(19) United States
(12) Patent Application Publication
(10) Pub. No.: US 2019/0370295 A1
(43) Pub. Date: Dec. 5, 2019

(54) SYSTEM AND METHOD FOR NAVIGATING DOCUMENTS

(71) Applicant: PB Innovate Pty Ltd, Ringwood (AU)

(72) Inventor: Pieter de Boer, Mount Evelyn (AU)

(21) Appl. No.: 16/383,530

(22) Filed: Apr. 12, 2019

Related U.S. Application Data
(63) Continuation of application No. PCT/AU2017/000213, filed on Oct. 10, 2017.

(30) Foreign Application Priority Data
Oct. 12, 2016 (AU) 2016904138

(51) Int. Cl. G06F 16/93; G06F 16/904; G06F 3/0483

(52) U.S. Cl. CPC G06F 16/93; G06F 3/0483; G06F 16/904

(57) ABSTRACT

A method for creating a searchable database of a set of documents having been prepared according to one or more native referencing protocols, the method including generating for each and every one of the documents in the set, one or more standard reference coordinates for segments defined by the native referencing protocol used to prepare the documents such that every native segment in the set of documents is defined according to the one or more standard reference protocol coordinates which define a spatial location and area of the native segment in an image of the document, such that a user, upon identifying a segment within the set of documents that contains a component of interest and selecting the segment in which the component of interest is located, causes information associated with components in the selected segment to be displayed

### CROSS-REFERENCE TO RELATED APPLICATIONS

This application is a continuation of International Application No. PCT/AU2017/000213, filed Oct. 10, 2017, and claims benefit of priority of Australian Patent Application No. 2016904138 filed Oct. 12, 2016. The disclosures of the prior applications are considered part of the disclosure of this application and are herein incorporated by reference.

### FIELD OF THE INVENTION

The present invention relates to a system and method that enables a related set of technical drawings, process control diagrams and/or other types of documentation that have been generated using one or more native referencing protocols, to be navigated using a standard referencing protocol. The system and method of the invention may find use in navigating documents associated with process control systems such as those used in industrial/chemical processing and mining operations, and in particular, during fault- finding and/or rectification works.

### BACKGROUND OF THE INVENTION

Processing facilities in industrial/chemical and mining operations typically utilise control systems such as SCADA (Supervisory Control and Data Acquisition), PLC (Programmable Logic Controller) and DCS (De-centralised (or Distributed) Control System) type systems for monitoring and controlling equipment and processes. Control systems allow an operator to easily view what is occurring with the equipment and/or processes, usually in real time, and often in a stylised diagrammatic (image) format representing key components of the process control system or the production system. If equipment or processes fail, or do not work at optimum capacity, then the control system is enabled to send an alarm which is received by the operator so that the problem that is causing the alarm can be rectified.

Fault-finding within electrical and mechanical systems of processing facilities is frequently very time consuming and typically leads to long periods of down time which is expensive. The fault resolution process, in one view, can be divided into two parts: determining the location and nature of the fault, and fault rectification. Whilst fault rectification is normally a relatively quick process, the time required for determining the location and nature of the fault tends to be longer and can extend to hours, or possibly days.

Locating a fault is typically achieved by searching and navigation of technical documents (images), such as Piping and Instrumentation (P&I) diagrams, which describe the components, operation and control aspects of processing facilities. Such documents typically contain a high level of detail and are often complex and lengthy (often in excess of 1,000 pages) and hence the difficulty associated with searching and navigating such documents.

Adding to the complexity of searching and navigating technical documents such as P&I diagrams is the fact that components in one drawing often refer to components in other drawings; for example, a contactor (or electrically operated switch) may be defined in a number of drawings in which the actuator (coil) of the contactor is defined in one drawing, the switching contacts of the contactor are defined in another drawing and the mechanical panel layout is defined in yet another drawing. In addition, navigating information associated with a component of interest within the set of technical drawings is difficult due to the vast amount of information and the number of documents that typically exist for large installations such as chemical processing facilities. As such, it is difficult to search, navigate and identify information when attempting to identify a resolution for a fault.

Most technical documents are generated with reference to a native referencing protocol which divides the document into a number of grid cells or “segments” in accordance with the native referencing protocol similar to street directories before the advent of global position satellite systems. These segments assist in searching and/or navigation of technical documents by subdividing the document into a number of segments that are usually of uniform size. However, one of the difficulties in navigating between various technical documents is that technical documents are typically created by different drawing contractors who use different drawing tools (e.g., Computer Assisted Design (CAD) systems) that each have a specific referencing protocol that is native to the specific drawing tool (and the preferences of its users resulting in differences between the standards). For example, two common native referencing protocols used in the preparation of electrical drawings are the European IEC (International Electrotechnical Commission) standard or the American JIC (Joint Industrial Council) standard. However, these two native referencing protocols are fundamentally different and hence, cross referencing between drawings according to the different standards is difficult. In addition, many other referencing protocols are also available as alternatives to the JIC and IEC standards which are all substantially different from each other regarding the definition of segments.

Furthermore, it is not unusual for technical documents relating to a single control system to have documents prepared with different native referencing protocols which therefore renders the navigation of documents difficult as the definition of a segment in one document does not correlate with the definition of the same segment within other documents due to the different native referencing protocols used to prepare the documents.

For example, a large processing facility such as an oil refinery will have thousands of associated documents created by many different drawing contractors and therefore the documents relating to a single control system will not conform to a single drawing referencing protocol. This makes navigation of the information between documents very difficult and, as such, technical drawings tend to be used as discrete pieces of information by users who tend to search for components and/or faults according to component identification (ID) numbers and/or document ID numbers, which leads to a non-intuitive approach in respect of searching and navigating technical documents and as skilled readers will recognise, limiting searching and navigating technical drawings to a non-intuitive approach makes fault-finding difficult and, at times, impossible to execute in a timely and efficient manner.

In order to address this problem, various solutions have been proposed to enable linking of information between documents that include: (i) the entry of pdf links within pdf formats of existing documents; (ii) the development of specialist software that scans and analyses existing drawings and creates a unique proprietary electronic model of the drawings including references and links to other drawings; and (iii) re-drawing existing drawings using a single CAD drawing system. However there are problems associated with each of these proposed solutions.

For instance, the first proposed solution requiring the entry of links in pdf documents is highly prone to error and prohibitively expensive as it may take many hours per drawing to review, determine and implement the required linking within documents. Furthermore, when different CAD drawing software products have been used to generate pdf documents, inclusion of pdf links within the documents is often not possible, or at best, cumbersome. Still further, documents produced using different CAD software will not be of a uniform or universal standard thereby resulting in the need for a variety methods to be used to search and navigate documents which is confusing.

The second proposed solution is also not satisfactory as the specialist software does not use the native (or original) segment referencing of the drawings thereby not allowing correlation between documents. A further drawback associated with specialist software of the second proposed solution, is that such software typically utilises symbol recognition software that requires calibration and/or additions for different drawing methods and referencing systems. This generally means requires continuous refinement and/or additions by technical specialists.

The third proposed solution of re-drawing existing documents using a single CAD drawing system is also error prone and usually prohibitively expensive.

The present invention attempts to address the abovementioned disadvantages associated with conventional searching and navigation methods of technical documents.

### SUMMARY OF THE INVENTION

In one aspect, the present invention provides a method for creating a searchable database of a set of documents having been prepared according to one or more native referencing protocols, the method comprising: generating for each and every one of the documents in the set, one or more standard reference coordinates for segments defined by the native referencing protocol used to prepare the documents such that every native segment in the set of documents is defined according to the one or more standard reference protocol coordinates which define the spatial location and area of the native segment in an image of the document, such that a user, upon identifying a segment within the set of documents that contains a component of interest and selecting the segment in which the component of interest is located, causes information associated with components in the selected segment to be displayed.

In an embodiment, the searchable database includes a link such that upon activating an item of information associated with a component in a selected segment causes the generation of a display of an image of the associated segment or segments, of the document or documents pertaining to the associated information.

In an embodiment, an image of each and every document obtained in a single standard reference protocol is applied such that the spatial location and area of the native segments in each document image is defined according to the single standard reference protocol.

In another aspect, the present invention provides a method of navigating a set of documents having been prepared according to one or more referencing protocols by a user, wherein standard reference coordinates for segments defined by the native referencing protocol used to prepare the documents have been generated for each and every one of the documents in the set, such that every native segment in the set of documents is defined according to standard reference protocol coordinates which define the spatial location and area of the native segment in an image of the document; the method comprising the user identifying a segment within the set of documents that contains a component of interest and selecting the segment in which the component of interest is located thereby causing information associated with components in the selected segment to be displayed.

In an embodiment, the information that is displayed is selectable by the user to navigate the user to another document within the set of documents.

In an embodiment, the one or more components include, but are not limited to, any one of a device, an input and output component of a control system (IO-Point) or a jump point.

It will be understood that the phrase “jump point” is intended to indicate within the context of the invention, a virtual interconnection between a representation of a physical wire or pipe shown in one document and a representation of that same physical wire or pipe shown in another drawing. In this regard, it is usually not practical or feasible to include all representations wires and/or pipes (and the like) throughout a system on the same document. Accordingly, virtual links or “jump points” are included in an embodiment in order to facilitate navigation of the system as a whole as represented across a number of drawings within a set of drawings.

In an embodiment, the generation of standard reference coordinates is achieved with the use of a reference definition, wherein the reference definition includes one or more measurements of the one more documents generated using a particular native referencing protocol, and further includes one or more values of the one or more documents generated using a particular native referencing protocol, wherein the one or more measurements and the one or more values are used to calculate reference definition output data that pertain to a particular set of documents that have been prepared using a native referencing protocol with a particular format.

It will be understood that documents prepared according to a particular native reference protocol may also include slight modifications (of the native protocol guidelines) and yet still be classified according to the definitions and guidelines of particular native protocol. Accordingly, different “formats” of the same native referencing protocol may exist.

As an example, a particular native referencing protocol may specify a series of columns referenced by letters of the alphabet and a series of rows referenced by numbers. Within this native referencing protocol, one drawing contractor may choose, for example, to label the columns as “A” to “Z” moving left to right across the document page whilst another drawing contractor may choose to apply the same native protocol but label the columns “Z” to “A” moving left to right across the document page. Despite the different ordering of the column labels, both examples would be classified within the same native referencing protocol and the same reference definition is able to be applied to both examples despite the different formats of the same native protocol in the two examples in order to generate the standard reference coordinates.

It will be appreciated in this regard that whilst each native referencing protocol will have a single reference definition, irrespective of the format of the native protocol, the reference definition output data will vary for each set of documents prepared according to native reference protocols with different formats.

In an embodiment, the one or more measurements of a document include, but are not limited to, the width of the document, the height of the document and the document border dimensions (i.e., the distance between the edge (or periphery) of the document and the edge (or periphery) of the graphic within the document).

In an embodiment, the one or more values of an document include, but are not limited to, the number of rows used within the native referencing protocol, the number of columns used within the native referencing protocol, the height of the rows used within the native referencing protocol and the width of the columns used within the native referencing protocol. Further values may include the number and height of any additional rows used within the native referencing protocol or the number and width of any additional columns used within the native referencing protocol.

In an embodiment, the method may be used to search for, and locate, faults within processing systems and installations, for example, faults occurring within the processing and/or control system of a chemical processing facility.

In an embodiment, the control system includes a supervisory control and data acquisition (SCADA) system, a programmable logic controller (PLC) or a decentralised (or distributed) control system (DCS).

In an embodiment, a document is any type of document generated using a grid referencing protocol, for example, Cartesian coordinates, and may include documents including, but not limited to, a process control diagram, an electrical drawing, a Piping and Instrumentation (P&I) diagram, an architectural drawing, a geographical map or a road map. The documents may be in any file format however in an embodiment, the file format is a PDF (portable document format). In embodiments, the documents are converted to PNG (portable network graphics) format during import to the system database of the invention.

In an embodiment, the import of the documents within a set of documents includes: determining the reference definition and calculating reference definition output data for one or more documents prepared using a native referencing protocol and storing the reference definition output data in the system database, using the reference definition output data to generate standard reference coordinates based on the native segment reference coordinates.

In embodiments, the documents may include any one or more of: circuit diagrams, electrical diagrams, circuit layout diagrams, hydraulic diagrams, pneumatic diagrams, loop diagrams, and, process flow diagrams. In addition to including diagrammatic information, the documents may also include non-diagrammatic information, including data sheets, such that when at least one segment of a document is selected within which one or more components of interest are depicted in the diagrammatic information (image), both diagrammatic and non-diagrammatic information associated with the one more components of interest is displayed. In embodiments, the one or more components have a unique identification (ID reference or number), which is input for association (i.e., linking) with other relevant information stored within the system database.

In an embodiment, a set of documents may include all documents that are relevant in controlling a particular processing facility for example a chemical/industrial processing facility or a mining facility. In other embodiments, a set of documents may be all of the architectural drawings relating to a single dwelling or project. In yet other embodiments, the set of documents may be set of electrical drawings relating to an installation. Accordingly, the phrase “set of documents” is intended to be broadly interpreted within the context of the present invention and may define a group of documents having some common element.

The use of the term “native reference protocol” within the context of the invention is intended to refer to any known (common) referencing protocol or any unique referencing protocol adopted in the generation of drawings. For example, two common native referencing protocols used in the generation of electrical drawings is the European IEC (International Electrotechnical Commission) method or the American JIC (Joint Industrial Council) method of referencing.

It will be appreciated however that the system and method of the present invention in an embodiment is able to transform any native referencing protocol (whether common (known) or unique) so as to define the native coordinates as standard coordinates and thereby enable navigation of all documents within a set of documents (possibly generated using different native referencing protocols) by the use of a single standard referencing protocol.

The documents may be electronically generated, imported into and stored on the system database as one or more electronic files. In other embodiments, the documents may be physical (hardcopy pdf) documents that require scanning and saving as, example, png file format, prior to import into the system database of the invention. It will be appreciated that in some instances, the native referencing protocol adopted during the preparation of one or more documents within a set of documents will be unknown, and in these instances, the values and measurements of native protocol reference coordinates will have to be initially determined prior to generating the standard reference coordinates.

In embodiments, the components displayed with any document may include any device, IO-Points, “jump points” or alarms on logic diagrams.

A device may include any physical component including, but not limited to, sensors, switches, transmitters, transducers, remote terminal units (RTUs), programmable logic controllers (PLCs), contacts, wires, cables, connections, electrical circuits, electrical components, electro-mechanical components, electronic components, hydraulic components, pneumatic components and actuators. However devices do not have to be limited to those that would typically be displayed in any electrical drawing or Piping & Instrumentation diagram, and may include, in other embodiments, roads, buildings, train stops/stations and natural landmarks (rivers) etc., displayed in road maps, or building components (e.g., doors, windows etc.,) displayed in architectural drawings.

The input and output components of a control system (IO-Points) are the (semi-physical) connection points to the physical devices.

It will be understood that the term “segment” in relation to a document is intended to define, in one embodiment, a single reference grid cell.

In an embodiment, the user is able to select a segment of a document within which a component of interest is located by the use of a virtual cursor controlled by an electronic input device. In an embodiment, various sections of the displayed document are able to be highlighted by the user by moving the virtual cursor over the displayed document with the use of their electronic input device. In an embodiment, only the segments of the document in which one or more components are located will be highlighted. Accordingly, in this embodiment, any segments of the document that do not contain any associated components will not be highlighted when a user moves their virtual cursor over the document with the use of their electronic input device.

In yet another aspect, the present invention provides a system for navigating one or more documents within a set of documents that have been prepared according to one or more native referencing protocols, the system comprising: a user interface enabling a user to navigate the one or more documents within the set of documents; a database for storing one or more standard reference coordinates that have been generated for each and every one of the documents in the set, the standard reference coordinates for segments defined by the native referencing protocol used to prepare the documents such that every native segment in a set of documents is defined according to standard reference protocol coordinates which define the spatial location and area of the native segment in an image of the document; a processor for generating one or more standard reference coordinates for segments defined by the native referencing protocol used to prepare the documents for each and every one of the documents within the set of documents; a linking module that enables one or more components located within a document to be linked, by use of the one or more standard reference coordinates, with one or more components located within one or more other documents thereby enabling a user to identify a component of interest in one segment within the set of documents and upon selecting the segment in which the component of interest is located to thereby cause information associated with the selected segment to be displayed, wherein the information that is displayed is further selectable by the user to cause the relevant document within the set of documents pertaining to the associated information to be displayed to the user.

In an embodiment, the database for storing one or more standard reference coordinates also stores one or more native referencing protocols, reference definitions and reference definition output data that are used to generate the one or more standard reference coordinates.

In an embodiment the user interface is a graphic display.

### BRIEF DESCRIPTION OF THE FIGURES

Embodiment(s) of the invention will now be described in further detail with reference to the accompanying figure(s) in which:

FIG. 1 is a diagrammatic representation of an example screenshot showing information displayed in a possible scenario according to an embodiment of the present invention.

FIG. 2 is a diagrammatic representation of an example screenshot of a user interface graphic display according to embodiment of the invention that shows the search results for a component associated with alarm (ID No. AL000408) within a process control system and a list of available IO-Points associated with that alarm.

FIG. 3 is a diagrammatic representation of an example screenshot of a user interface graphic display according to the embodiment shown in FIG. 2, however, with the second IO-Point shown as selected within the list of available IO-Points.

FIG. 4 is a screenshot of a user interface graphic display according to the embodiment shown in FIGS. 2 and 3 that shows, in particular, another segment of the document whilst being selected by the user (i.e., grid area reference A1 in the left top hand corner).

FIG. 5 is a screenshot of a user interface graphic display according to the embodiment shown in FIGS. 2, 3 and 4 with grid area reference A1 shown as selected.

FIG. 6 is a schematic drawing showing the steps involved in calculating referencing definition output data to generate standard reference coordinates in accordance with an embodiment of the invention.

FIG. 7 is a diagrammatic representation of a document organized into segments defined by a reference coordinate system that may be processed by the described system and method in accordance with an embodiment of the invention.

### DETAILED DESCRIPTION OF EMBODIMENT(S) OF THE INVENTION

For convenience, the invention will be described with respect to a particular embodiment, however it will be appreciated by those skilled in the art that the invention is not limited to this particular embodiment.

### Application of the System and Method of the Invention According to One Embodiment

A documentation depository for any given installation (e.g., a chemical processing plant) will typically contain a vast amount of stored information (or data) for use within a process control system. The standard referencing protocol in accordance with an embodiment of the invention assists users of process control systems to search and navigate the stored information in order to identify any component of interest including, but not limited to, contactors, switches, relays, valves (hydraulic or pneumatic) or the like within the processing system, input and/or output connection points (IO-Points), and such components associated with system alarms. It will be understood that 10-points are semi-physical and are the connection points (physical) to the inputs and outputs (analogue or digital) of an automation controller. It will also be understood that control systems, for example Distributed Control Systems, typically adopted in large facilities such as oil refineries, contain several thousand I/O points and therefore the associated documentation is difficult to search and navigate.

The system and method of the present invention provides a user with a visual means of navigating vast depositories of information in a more intuitive, efficient and user friendly manner that facilitates, in one embodiment, fault-finding and rectification works. In this regard, it will be appreciated that conventional means of fault-finding requires searching vast amounts of discrete information (drawings) without any ability to efficiently navigate the vast amount of documents in order to investigate one area or component of the system in relation to other components and areas of the system displayed in other documents. Accordingly, conventional methods of searching vast amounts of information and images is extremely difficult, time consuming and therefore costly.

The system and method of the invention enables a user to visually search (as opposed to having to input document and/or component ID references or numbers) and thereby navigate large sets of documents in order to identify any component and/or information of interest. The system and method of the invention also enables information in the documents to be linked (in this embodiment by electronic linking of various components with the use of hyperlinks) to thereby enable a user to visually search and navigate a set of documents irrespective of the drawing tools and referencing protocols used to generate individual documents within the set of documents.

The visual representation of components and any associated information within a document combined with the ability to navigate a set of documents by selecting segments of the documents in which components of interest are located, all within the context of surrounding components of a system, creates a more intuitive approach to searching and fault-finding wherein a user is able to view the component of interest in addition to surrounding components and associated information. Accordingly, the system and method of the invention avoids limiting a user having to conduct only a text based search (usually by inputting component identification references and/or numbers) in order to find a fault and ascertain all relevant information associated with a component of interest (for example, an IO-Point associated with an alarm).

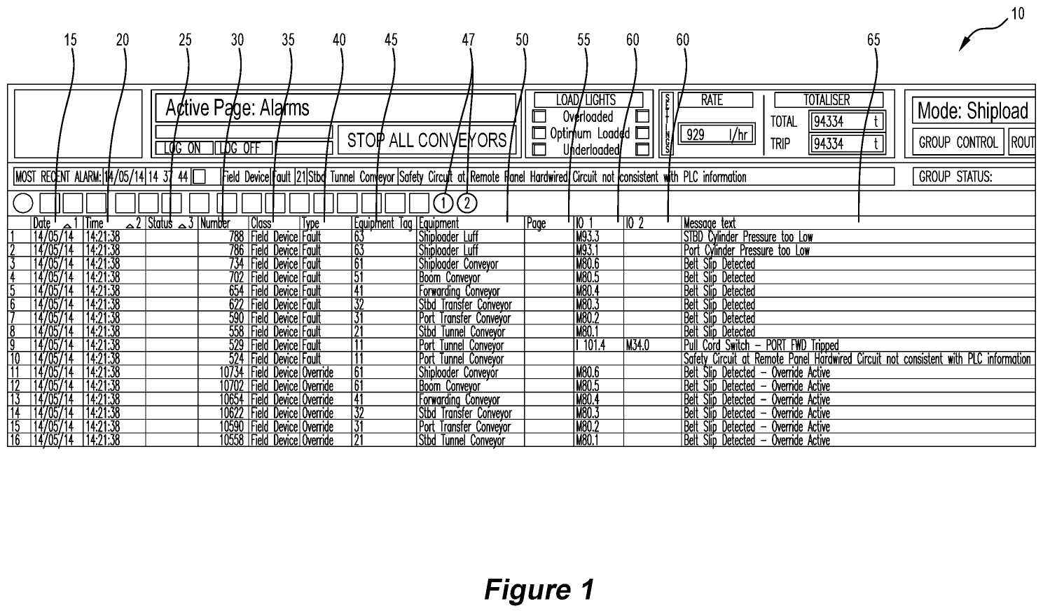

For example, when a user such as a processing facility operator detects, or is alerted to, a potential malfunction or fault within the processing facility by an alarm within the facility control system, the user can access a window display listing an active page of alarms as shown in FIG. 1. Window display 10 shows information associated with a number of different alarms. Each alarm is displayed in a numbered row window, with data associated with the alarm displayed in the columns. The columns include: date 15, time 20, status 25, number 30, class 35, type 40, equipment tag 45, equipment 50, page 55, buttons 47 related to inputs and/or outputs 1 and 2 60, and message text 65.

It will be understood that the alarms produced by the control system include true alarms, if a condition is satisfied in the processes and/or equipment, wherein for example, a piece of equipment or a process is not functioning in an expected or an acceptable manner such that the input and/or output components associated with the equipment or process will send data to the control system indicating the abnormal state of the process or equipment. This may be regarded as normal functioning of the control system which enables the operator to make adjustments or repairs to the processes or equipment. Sometimes the adjustments or repairs can be made via the control system. Other times the adjustments or repairs must be made to the equipment or processes themselves.

In other circumstances, it is possible that equipment and/or processes in a chemical processing facility may operate within normal or expected parameters, but the input and/or output components themselves are faulty causing data to be sent to the control system which causes the control system to produce a false alarm. It is such false alarms that can be very difficult to detect and repair, especially where there may be a very large number of input and/or output components connected to the control system.

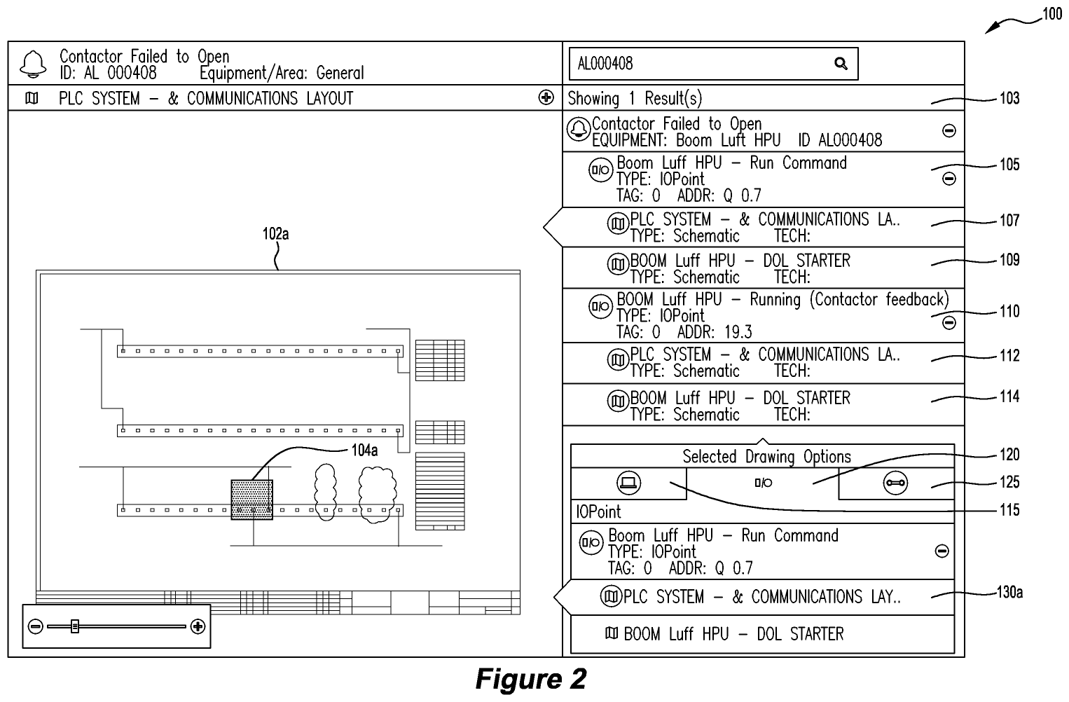

Referring once again to FIG. 1, the operator may select any alarm of interest in display window 10 and once selected, will be presented with visual information associated with that particular alarm as shown in the screenshot of a user interface graphic display of FIG. 2. More specifically, FIG. 2 displays information relating to a component associated with alarm (ID No. AL000408) including image 102a and on the right hand side of image 102a, results menu 103. FIG. 2 also shows highlighted grid area (or segment) 104a and lists all information in respect of the component of interest associated with alarm (ID No. AL000408) including IO-Point 105 (and available menu selections 107, 109 corresponding to IO-Point 105) and IO-Point 110 (and menu selections 112, 114 corresponding to IO-Point 110). FIG. 2 also shows menu selection 107 as selected which corresponds to drawing 102a.

FIG. 2 further displays all available information relating to highlighted segment 104a in window entitled “Selected Drawing Options” displayed below results menu 103 and provides the operator with access to information relating to all devices (via tab 115), IO-Points (via tab 120) and Jump Points (via tab 125) available within segment 104a. It will be understood that a “jump point” within the context of the invention is taken to mean a virtual interconnection between two documents whilst referring to the same component (for example, a power wiring connection or a fluid flow pipe). FIG. 2 also shows arrow 130a that identifies drawing 102a currently selected and displayed.

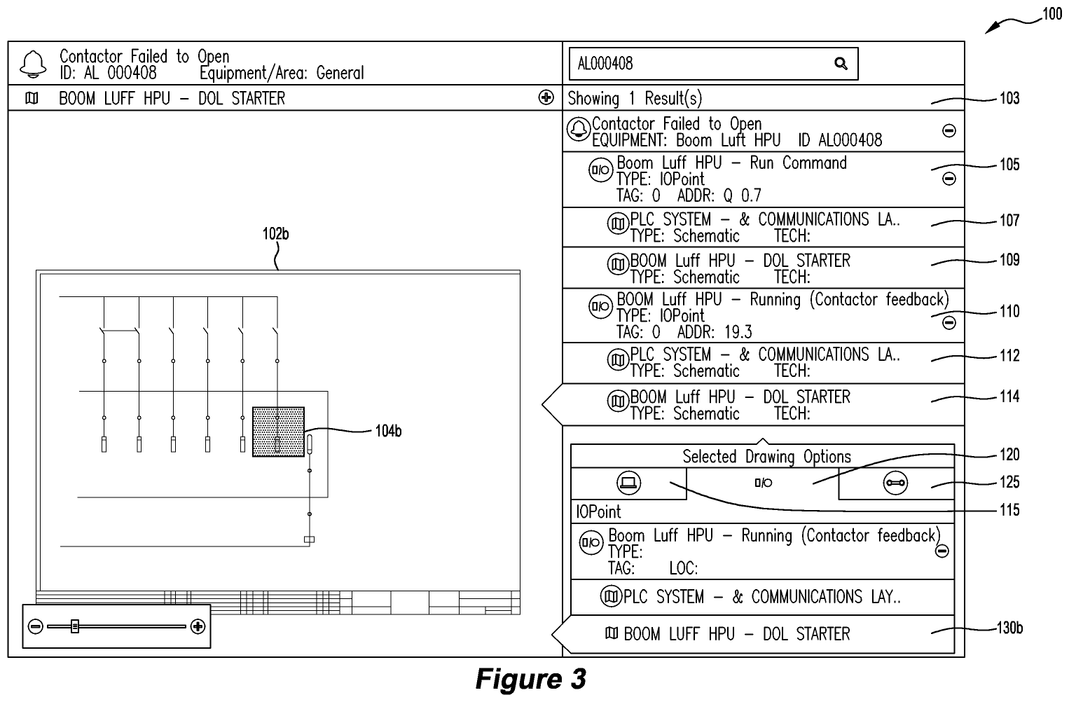

If a user decides to select information relating to IO-Point 110 and selects menu selection 114, the user will be presented with a different drawing as shown in the screenshot of FIG. 3 that shows different drawing 102b and also the relevant highlighted segment 104b. As shown in FIG. 2, FIG. 3 displays the same search results for alarm (ID No. AL000408) and lists all information associated with this component including IO-Point 105 (and available menu selections 107, 109 corresponding to IO-Point 105) and IO-Point 110 (and available menu selections 112, 114 corresponding to IO-Point 110). However, as a different grid area is now highlighted in FIG. 3 (i.e., segment 104b), different information appears in the window “Selected Drawing Options” displayed below results menu 103 compared to FIG. 2.

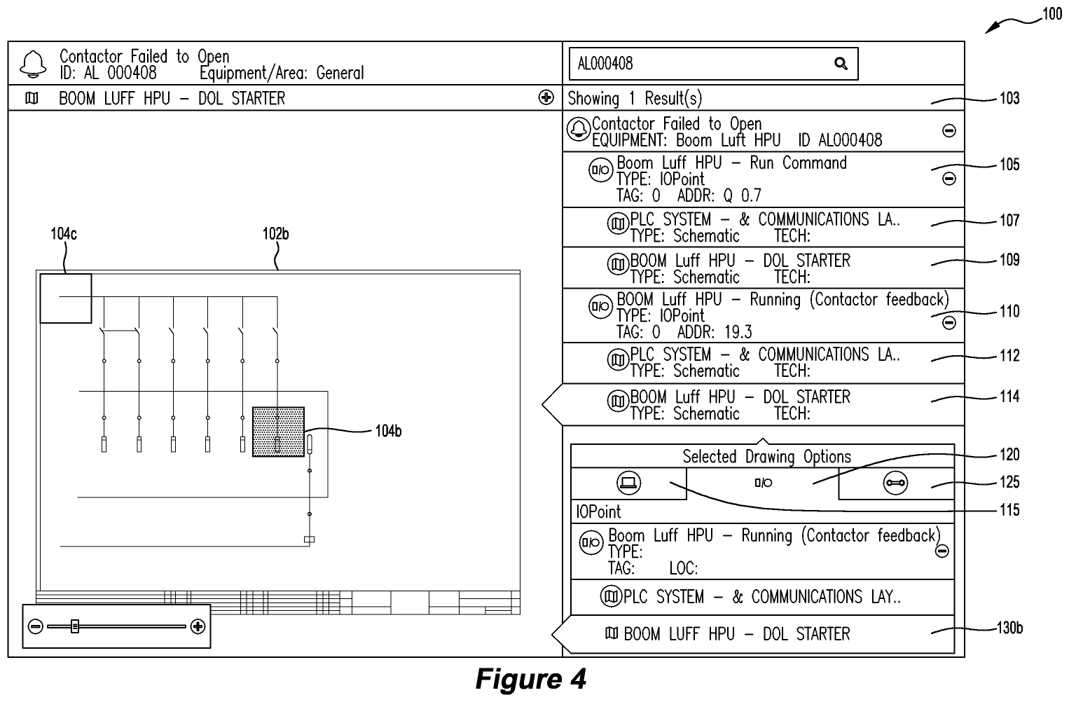

It will be understood that any grid area (segment) of a drawing may be manually highlighted and selected by a user hovering a virtual cursor over the drawing at a location of interest by the use of their electronic input device. An example of this is shown in FIG. 4, in which the operator is hovering a virtual cursor in the top left hand corner of drawing 102b in which segment 104c is shown with a dotted border, thereby indicating to the user that this segment has associated information relating to other components and/or drawings. In this regard and in this embodiment, only those segments of the image that are associated with information about other components and drawings will appear with a dotted border once a virtual cursor hovers over that segment thereby indicating to the user that that particular segment of the drawing is linked to other information and/or drawings. Accordingly, any segment of the image having no associated information relating to any component and/or drawings will not be highlighted.

As shown in FIGS. 2 and 3, FIG. 4 also displays the search results for alarm (ID No. AL000408) and lists all information associated with this component including IO-Point 105 (and available menu selections 107, 109 corresponding to IO-Point 105) and IO-Point 110 (and available menu selections 112, 114 corresponding to IO-Point 110). As the same grid area is highlighted (i.e., segment 104b) in FIG. 4, the same information appears in the window “Selected Drawing Options” displayed below results menu 103 as in FIG. 3.

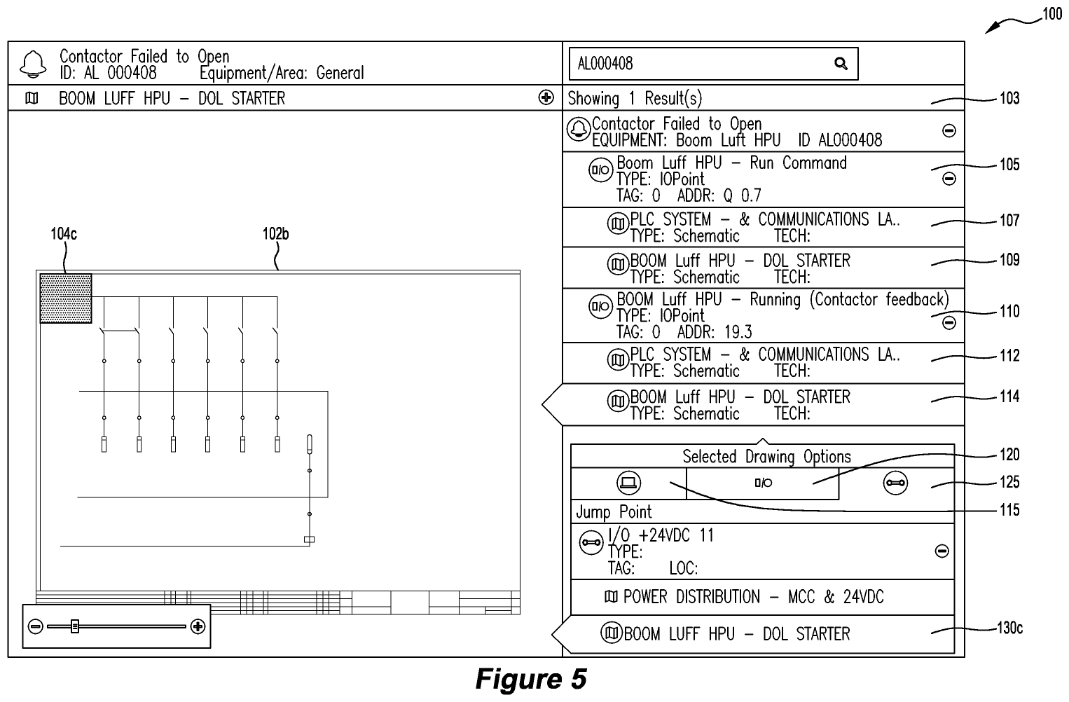

Upon manual selection of segment 104c by the operator, segment 104b will disappear and segment 104c is subsequently highlighted as shown in FIG. 5. FIG. 5 also displays the same search results for alarm (ID No. AL000408) and lists all information associated with this component including IO-Point 105 (and available menu selections 107, 109 corresponding to IO-Point 105) and IO-Point 110 (and available menu selections 112, 114 corresponding to IO-Point 110). However, as the different grid area is now highlighted (i.e., segment 104c) in FIG. 5, different information appears in the window “Selected Drawing Options” displayed below results menu 103 compared to FIG. 4.

Accordingly, the above example demonstrates that the system and method of the invention, according to an embodiment, provides a more efficient and intuitive searching approach compared to conventional searching techniques of technical documents, particularly in fault-finding and/or rectification works.

### Determination of a Reference Definition and Associated Reference Definition Output Data for a Set of Drawings Prepared According to the IEC Referencing Protocol and Particular Format

The following example, demonstrates the use of a reference definition based on the IEC (International Electrotechnical Commission) referencing protocol to calculate reference definition output data that may subsequently be used to generate standard reference coordinates based on the native segment reference coordinates within a drawing.

The IEC reference method utilises a grid that is based on rows and columns, similar to that of a street map. However, as previously mentioned, different formats of the same native referencing protocol will exist, (e.g., the number of rows, columns, characters (alphabetic and numeric) and excluded characters will differ and appear arbitrary, but will nevertheless adhere to a broad set of guidelines specified for each native referencing protocol.

Accordingly, whilst a single reference definition is able to be defined for each native referencing protocol, each reference definition will generate different reference definition output data for any given set of drawings prepared by the same native referencing protocol and format based on the measurements and values entered for a particular drawing set. Accordingly, the system and method according to any embodiment is able to accommodate the flexible nature of different native protocol formats as they differ between drawing contractors.

### Reference Definition

The “Reference Definition” may be regarded as a “vehicle” that provides the data (“output data”) required to perform the calculations for generation of the standard reference coordinates based on the reference coordinates of the native segments within a document.

Variations in Native Referencing Protocols (Formats)

The system and method of the invention is able to accommodate many variations of the IEC referencing protocol provided various rules are adhered to as follows:

### Rules

1. The reference method may “list” the row reference first and column reference second (referred to as “RC”) or the column reference first and row reference second (referred to as “CR”).
2. The column and row reference components in the reference may each vary in length.
3. The column reference component may be numeric or alphabetic (providing the row reference component is of the opposing type).
4. Specific alphabetic characters can be excluded from the IEC reference string in order to prevent confusion and mistakes, for instance when 0 (zero) can be read as the letter “O”.
5. The column reference as observed from left to right may increase or decrease; the system and method of the invention allows for both options.
6. The row reference as observed from top to bottom may increase or decrease; the system and method allows for both options.
7. Different drawing dimensions and grid (segment) dimensions are allowed.

### Reference Definition Information

The calculation of reference definition output data for a set of drawings (all prepared using the same IEC reference protocol format), requires drawing measurements and values to be entered into the system database based on a particular drawing set.

The measurements that are required to be entered are as follows:

| Item | Abbreviation | Description | Validation |
|---|---|---|---|
| 1 | | mm/inches/pixels (no active | n/a |
| | | function) | |
| 2 | a | Drawing Image - Width | none |
| 3 | b | Drawing Image - Height | none |
| 4 | c | Distance from LH side of | c < a |
| | | drawing image to LH side | |
| | | of most LH Column | |
| 5 | d | Distance from LH side of | d < a ∧ d > c |
| | | drawing image to RH side | |
| | | of most RH Column | |
| 6 | e | Distance from Top of | e < b |
| | | drawing image to Top of | |
| | | Top Row | |
| 7 | f | Distance from Top of | f < b ∧ f > e |
| | | drawing image to Bottom | |
| | | of Bottom Row | |

NOTES:
1. ∧ = AND, ∨ = OR
2. Items 2(a) and 3(b) relate to the height and width of the drawing image and not the paper size of the printed drawing

The values that are required to be entered are as follows:

| Item | Abbreviation | Description | Validation |
|---|---|---|---|
| 1 | A | Reference Method is RC | Use dropdown box |
| | | (Row/Column) or CR | |
| 2 | B | LH Column Reference | Number ∨ Letter |
| | | | (see Note 2) |
| 3 | C | RH Column Reference | Same type as B |
| | | | (see Note 2) |
| 4 | D | Top Row Reference | Inverse Type from B |
| | | | (see Note 2) |
| 5 | E | Bottom Row Reference | Inverse Type from B |
| | | | (see Note 2) |
| 6 | F | Excluded Alphabetic | Single Alpha. |
| | | characters (separator | Char/entry |
| | | required) | |
| 7 | G | # of reference | (Reserved for Future) |
| | | characters representing | (see Note 3) |
| | | Column value | |
| 8 | H | # of reference | (Reserved for Future) |
| | | characters representing | (see Note 3) |
| | | Row value | |

NOTES
1. ∧ = AND, ∨ = OR
2. Ensure that each reference is all alphabetic or all numeric, not a combination of both.
3. Reserved to account for possibility that number of characters for each row and column will need to be defined due to, for example, use of non-opposing column and row references (i.e., both either numeric or both either alphabetic)
4. For items 2 to 5, check for excluded characters as per item 6

It will be understood that the quantity and types of measurements and values will vary between the different definitions for each referencing protocol. In this regard, each referencing protocol will have its own reference definition that is used to calculate the reference definition output data. These output data are then used within specific algorithms developed for each reference protocol to calculate the standard referencing coordinates.

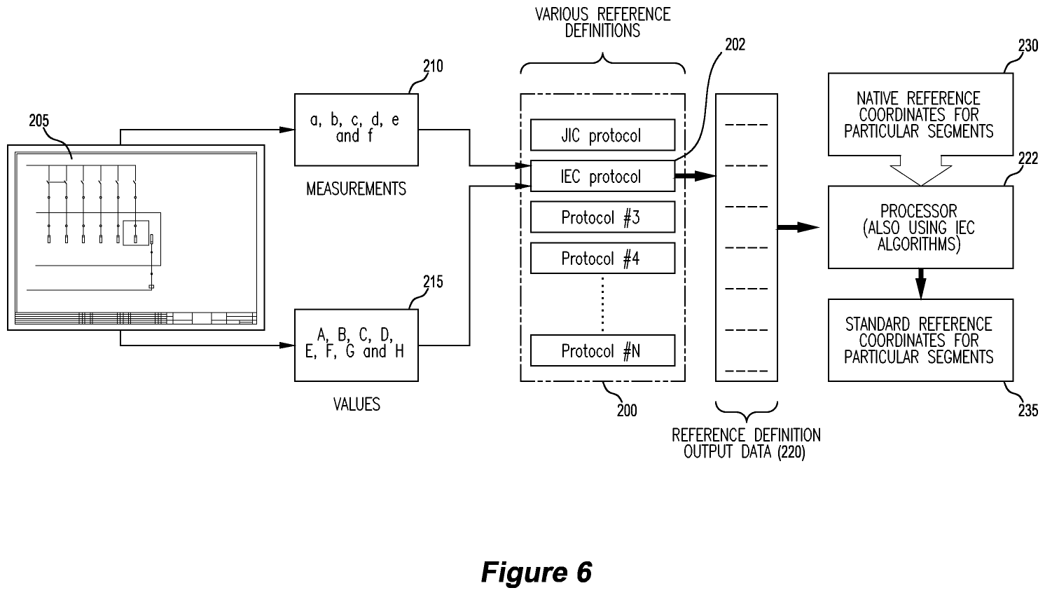

The steps involved in calculating standard reference coordinates for segments defined by the IEC referencing protocol used to prepare a document (drawing) within a set of documents is shown in FIG. 6. More specifically, FIG. 6 shows how reference definition output data are calculated with the use of various reference definitions 200 that have been specifically developed for various native referencing protocols (e.g. IEC, JIC etc.,). In this embodiment, the reference definition for the IEC referencing protocol 202 has been selected as drawing 205 has been prepared according to a particular format of the IEC protocol.

FIG. 6 also shows measurements 210 and values 215 pertaining to drawing 205, which together, are used to calculate reference definition output data 220. In order to calculate standard coordinates, reference definition output data 220 are used by processor 222 together with specific algorithms developed for the IEC referencing protocol, and also with native references 230 for particular segments to generate (calculate) standard reference coordinates 235 that correlate with the native reference coordinates of segments 230. Standard reference coordinates 235 that have been generated may then be used to correlate information between the documents, irrespective of the type and number of native reference protocols used to prepare the documents.

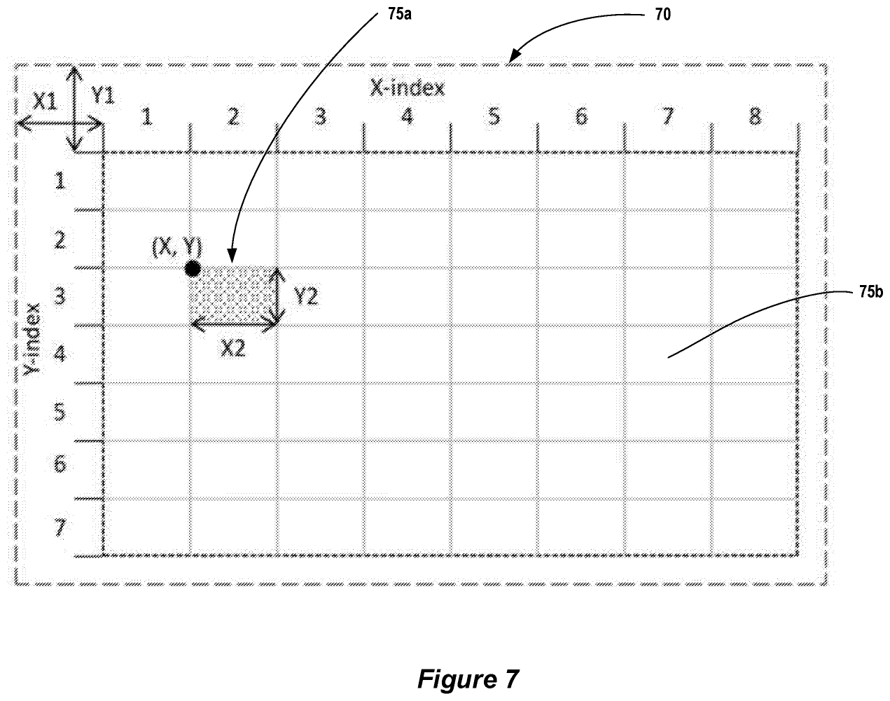

As shown in FIG. 7, a selected (highlighted) segment 75a within a document 70 may be defined in the form of four coordinates (X, Y, X2 and Y2) where it will be understood that the X, Y, X2 and Y2 coordinates together define cells (or segments), for example, segments 75a, 75b within the displayed document 70 as shown, and where:

X=X1+(X-index1)*X2

Y=Y1+(Y-index−1)*Y2

and where:

X and Y define the top-left coordinate of a selected segment, for example segment 75a;

X1 is the distance between the left hand side of the document and the left hand side of the graphic within the document;

Y1 is the distance between the top of the document and the top of the graphic within the document;

X2 is the width of a selected segment; and

Y2 is the height of a selected segment.

With continued reference to FIG. 7, the standard reference coordinates are relative reference coordinates where:

X, X1 and X2 are expressed as a percentage of the width of the displayed image; and

Y, Y1 and Y2 are expressed as a percentage of the height of the displayed document.

Accordingly, the system and method of the invention enables more efficient navigation of a set of documents, irrespective of the native referencing protocol used to prepare the documents, as standard reference coordinates are able to be used throughout the set of documents in order to link components (and associated information) throughout the documents and thereby allow navigation of the set of documents with respect to one or more components of interest.

The system and method of the invention also enables a user to efficiently navigate a large number of documents either by input of a relevant component reference ID (text base search), by selection of a relevant segment within the drawing in which a component of interest is located (and thereby cause associated information and drawings associated with that component to be displayed and which are selectable by the user), or by selection of associated menu options (e.g., drawings) associated with components located within highlighted segments of the drawing that upon selection, navigate the user to the relevant drawing and simultaneously highlights the relevant segment of the document to thereby clearly identifying the relevant component to which the drawing selection relates. It will be appreciated that this adds to the ease of searching and enables a more efficient method of locating components and/or faults, particularly in complex drawings such as electrical drawings that typically contain many components.

The system and method of the present invention, also provides the ability to conduct an integrated search of a vast amount of documents, irrespective of the native drawing tool (e.g., CAD software) and associated native referencing protocol used to prepare the documents, with the use of a single set of standard reference coordinates. As the generation of the standard reference coordinates preferably occurs at the time the data (images) are imported into the database associated with a process control system, the system and method according to an embodiment, can be used to search any type of document (having native referencing coordinates) and avoids the requirement to have highly skilled and/or specialised personnel to efficiently search and navigate the technical documents.

Additionally, as existing drawings/documentation do not have to be modified for use with the system and method of the present invention, the import of data and/or documentation of any given installation is less time consuming and therefore less expensive, and is also less prone to errors compared to situations in which drawings/documentation have to be modified before they can be used with the system of the present invention.

The reference to any prior art in this specification is not, and should not be taken as, an acknowledgement or any form or suggestion, that the prior art forms part of the common general knowledge.

Throughout this specification and the claims which follow, unless the context requires otherwise, the word “comprise”, and variations such as “comprises” and “comprising”, will be understood to mean the inclusion of a stated integer or step, or group of integers or steps, but not the exclusion of any other integer or step or group of integers or steps.

1. A method for creating a searchable database of a set of documents having been prepared according to one or more native referencing protocols, the method comprising:
generating for each and every one of the documents in the set, one or more standard reference coordinates for segments defined by the native referencing protocol used to prepare the documents such that every native segment in the set of documents is defined according to the one or more standard reference protocol coordinates which define a spatial location and area of the native segment in an image of the document,
such that a user, upon identifying a segment within the set of documents that contains a component of interest and selecting the segment in which the component of interest is located, causes information associated with components in the selected segment to be displayed.

2. A method according to claim 1 wherein, the searchable database comprises a link such that upon activating an item of information associated with a component in a selected segment causes the generation of a display of an image of the associated segment or segments of the document or documents pertaining to the associated information.

3. A method according to claim 1 wherein an image of each and every document is obtained and to which a single standard reference protocol is applied such that the spatial location and area of the native segments in each document image is defined according to the single standard reference protocol.

4. A method according to claim 1 wherein the set of documents are electronically generated and imported to a database as one or more electronic files.

5. A method according to claim 1 where the set of documents are physical documents that are scanned and imported to a database as one or more electronic files.

6. A method according to claim 4, wherein the import of the documents within a set of documents comprises:
determining a reference definition and calculating reference definition output data for one or more documents prepared using a native referencing protocol;
storing the reference definition output data in the system database; and
using the reference definition output data to generate standard reference coordinates based on the native segment reference coordinates.

7. A method of navigating a set of documents having been prepared according to one or more referencing protocols by a user, wherein standard reference coordinates for segments defined by the native referencing protocol used to prepare the documents have been generated for each and every one of the documents in the set, such that every native segment in the set of documents is defined according to standard reference protocol coordinates which define the spatial location and area of the native segment in an image of the document;
the method comprising the user identifying a segment within the set of documents that contains a component of interest and selecting the segment in which the component of interest is located thereby causing information associated with components in the selected segment to be displayed.

8. A method according to claim 7, wherein the information that is displayed is selectable by the user to navigate the user to another document within the set of documents.

9. A method according to claim 7, wherein the one or more components comprise any one of a device, an input and output component of a control system (IO-Point) or a jump point.

10. A method according to claim 7, wherein the generation of standard reference coordinates is achieved with the use of a reference definition, wherein the reference definition comprises one or more measurements of the one more documents generated using a particular native referencing protocol.

11. A method according to claim 10, wherein the reference definition further comprises one or more values of the one or more documents generated using a particular native referencing protocol, wherein the one or more measurements and the one or more values are used to calculate reference definition output data that pertain to a particular set of documents that have been prepared using a native referencing protocol with a particular format.

12. A method according to claim 10, wherein the one or more measurements of a document comprises any one or more of the following: width of the document, height of the document or document border dimensions.

13. A method according to claim 11, wherein the one or more values of the document comprise any one or more of the following: number of rows used within the native referencing protocol, number of columns used within the native referencing protocol, height of the rows used within the native referencing protocol or width of the columns used within the native referencing protocol.

14. A method according to claim 11, wherein the one or more values further comprises:
number of any additional rows used within the native referencing protocol, height of any additional rows used within the native referencing protocol, number of any additional columns used within the native referencing protocol, or width of any additional columns used within the native referencing protocol.

15. A method according to claim 7 wherein the set of documents are electronically generated and imported to a database as one or more electronic files.

16. A method according to claim 7 where the set of documents are physical documents that are scanned and imported to a database as one or more electronic files.

17. A method according to claim 15, wherein the import of the documents within a set of documents comprises:
determining a reference definition and calculating reference definition output data for one or more documents prepared using a native referencing protocol;
storing the reference definition output data in the system database; and
using the reference definition output data to generate standard reference coordinates based on the native segment reference coordinates.

18. A system for navigating one or more documents within a set of documents that have been prepared according to one or more native referencing protocols, the system comprising:
a user interface enabling a user to navigate the one or more documents within the set of documents;
a database for storing one or more standard reference coordinates that have been generated for each and every one of the documents in the set, the standard reference coordinates for segments defined by the native referencing protocol used to prepare the documents such that every native segment in the set of documents is defined according to one or more standard reference protocol coordinates which define a spatial location and area of the native segment in an image of the document;
a processor for generating one or more standard reference coordinates for segments defined by the native referencing protocol used to prepare the documents for each and every one of the documents within the set of documents;
a linking module that enables one or more components located within a document to be linked, by use of the one or more standard reference coordinates, with one or more components located within one or more other documents thereby enabling a user to identify a component of interest in one segment within the set of documents and upon selecting the segment in which the component of interest is located to thereby cause information associated with the selected segment to be displayed, wherein the information that is displayed is further selectable by the user to cause the relevant document within the set of documents further pertaining to the associated information to be displayed to the user.

19. A system according to claim 18, wherein the user interface is a graphic display.

20. A system according to claim 18, wherein the one or more documents is selected from any one or more of a process control diagram, an electrical drawing, a Piping and Instrumentation (P&I) diagram, an architectural drawing, a geographical map or a road map.
